(19) United States
(12) Patent Application Publication
(10) Pub. No.: US 2025/0293880 A1
(43) Pub. Date: Sep. 18, 2025

(54) MOBILE OBJECT, AUTHENTICATION SYSTEM, DATA STRUCTURE, INFORMATION PROCESSING METHOD, AND RECORDING MEDIUM

(71) Applicant: Panasonic Automotive Systems Co., Ltd., Kanagawa (JP)

(72) Inventors: Tomohisa SEZAKI, Kanagawa (JP); Takumaru NAGAI, Osaka (JP); Kaoru YOKOTA, Hyogo (JP); Akihito TAKEUCHI, Osaka (JP)

(73) Assignee: Panasonic Automotive Systems Co., Ltd., Kanagawa (JP)

(21) Appl. No.: 19/077,976

(22) Filed: Mar. 12, 2025

(30) Foreign Application Priority Data
Mar. 18, 2024 (JP) 2024-042735

(51) Int. Cl. H04L 9/32; H04L 9/30

(52) U.S. Cl. CPC H04L 9/321; H04L 9/3073

(57) ABSTRACT

A mobile object includes: a receiver that receives first authentication information transmitted by a first server that stores second authentication information from the mobile object, the first server being for providing a service contracted by a user of the mobile object; an obtainer that obtains mobile object data of the mobile object; and a transmitter that transmits, to a second server that collects mobile object data, the mobile object data to which third authentication information and the first authentication information have been added, the third authentication information being used for authentication using the second authentication information, wherein the first server stores fourth authentication information used for authentication using the first authentication information.

### CROSS REFERENCE TO RELATED APPLICATION

The present application is based on and claims priority of Japanese Patent Application No. 2024-042735 filed on Mar. 18, 2024.

### FIELD

The present disclosure relates to a mobile object, an authentication system, a data structure, an information processing method, and a recording medium.

### BACKGROUND

Conventionally, it has been considered to transmit various vehicle data obtained in a vehicle in which a user is riding to a server that provides various services to the vehicle or the user, and to provide the services using the vehicle data obtained by the server. For example, Patent Literature (PTL) 1 discloses an in-vehicle terminal device that can provide various services to self-driving cars used in car sharing.

### CITATION LIST

### Patent Literature

PTL 1: Japanese Unexamined Patent Application Publication No. 2019-175185

### SUMMARY

However, the mobile object and the like such as the vehicle according to PTL 1 can be improved upon.

In view of this, the present disclosure provides a mobile object, an authentication system, a data structure, an information processing method, and a recording medium capable of improving upon the above related art.

A mobile object according to one embodiment of the present disclosure is a mobile object including: a receiver that receives first authentication information transmitted by a first server that stores second authentication information from the mobile object, the first server being for providing a service contracted by a user of the mobile object; an obtainer that obtains mobile object data of the mobile object; and a transmitter that transmits, to a second server that collects mobile object data, the mobile object data to which third authentication information and the first authentication information have been added, the third authentication information being information used for authentication using the second authentication information, wherein the first server stores fourth authentication information used for authentication using the first authentication information.

An authentication system according to one aspect of the present disclosure is an authentication system including the mobile object, the first server, and the second server that are described above, wherein the second server transfers, to the first server, the mobile object data, to which the first authentication information and the third authentication information which have been received from the mobile object have been added, and the first server performs authentication based on: the fourth authentication information; the second authentication information; and the first authentication information and the third authentication information that have been added to the mobile object data.

An authentication system according to one aspect of the present disclosure is an authentication system including the mobile object, the first server, and the second server that are described above, wherein the second server stores the mobile object data to which the first authentication information and the third authentication information which have been received from the mobile object have been added, and when a request for the mobile object data is received from the first server, the second server performs authentication based on the fourth authentication information and the second authentication information that have been received from the first server, and the first authentication information and the third authentication information that have been added to the mobile object data.

A data structure according to one aspect of the present disclosure is a data structure of data transmitted from the mobile object to the second server in an authentication system including the mobile object, the first server, and the second server that are described above, the data structure including: the mobile object data of the mobile object; the third authentication information of the mobile object; and the first authentication information stored in the mobile object.

An information processing method according to one aspect of the present disclosure includes: receiving first authentication information transmitted by a first server, the first server storing second authentication information from the mobile object, the first server being a server for providing a service contracted by a user of a mobile object; obtaining mobile object data of the mobile object; and transmitting, to a second server that collects mobile object data, the mobile object data to which third authentication information and the first authentication information have been added, the third authentication information being information used for authentication using the second authentication information, wherein the first server stores fourth authentication information used for authentication using the first authentication information.

A recording medium according to one embodiment of the present disclosure is a non-transitory computer-readable recording medium having recorded thereon a program for causing a computer to execute the information processing method described above.

According to one aspect of the present disclosure, it is possible to realize a mobile object and the like capable of improving upon the above related art.

### BRIEF DESCRIPTION OF DRAWINGS

These and other advantages and features of the present disclosure will become apparent from the following description thereof taken in conjunction with the accompanying drawings that illustrate a specific embodiment of the present disclosure.

FIG. 1 is a block diagram showing the functional configuration of an authentication system according to an embodiment.

FIG. 2 is a diagram showing an example of authentication information to be added to vehicle data according to the embodiment.

FIG. 3 is a first sequence diagram showing the operation of the authentication system according to the embodiment.

FIG. 4 is a second sequence diagram showing the operation of the authentication system according to the embodiment.

FIG. 5 is a flowchart showing the detailed operation of step S31 shown in FIG. 4.

FIG. 6 is a diagram to explain the aggregation of vehicle data.

FIG. 7 is a diagram showing a first example of the data structure of vehicle data to which authentication information according to the embodiment has been added.

FIG. 8 is a diagram showing another example of authentication information to be added to vehicle data according to the embodiment.

FIG. 9 is a diagram showing a second example of the data structure of vehicle data to which authentication information according to the embodiment has been added.

FIG. 10 is a diagram showing a third example of the data structure of vehicle data to which authentication information according to the embodiment has been added.

FIG. 11 is a sequence diagram showing the operation of an authentication system according to a variation of the embodiment.

### DESCRIPTION OF EMBODIMENT

### (Circumstances Leading to the Present Disclosure)

In a software defined vehicle (SDV), collaboration between the cloud and connected cars is essential, and the cloud side (vehicle cloud server side) will receive various vehicle data (vehicle logs) from the vehicle. The vehicle data collected by these vehicle cloud servers (vehicle servers or original equipment manufacturer (OEM) servers) is also information linked to the user who uses the vehicle, and applications to various service fields are being considered. “Uses” may mean that the user drives the vehicle (e.g., a manually driven vehicle) or that the user rides the vehicle (e.g., a self-driving vehicle).

Since the OEM server is generally operated by the OEM that manufactures and sells the vehicle (or an OEM affiliated company), third parties such as service providers need to use vehicle data via the OEM (OEM server). The vehicle data is first transmitted from the vehicle to the OEM server, and after discussions and technical preparations (e.g., connection to a closed communication network, secure data authentication, etc.) between each service provider and the OEM, it is transferred from the OEM server to the service provider's service server. This poses the challenge that it is difficult for the service provider to handle vehicle data directly and simply. Since the transition to SDV and MaaS in the future is expected to require a more open form of vehicle data usage, it is desirable that improvements will be made to handle vehicle data directly and simply.

In addition, since users do not always use the same vehicle, for example, when using different vehicles (e.g. vehicles with different models, OEMs, or the like) for car sharing or the like, data management becomes complicated as vehicle data is transferred from the OEM server of another OEM. However, it is more efficient for the service provider to be able to centrally manage the vehicle data as the user's vehicle data, even if the vehicle changes, as long as the users are the same.

In addition, it is desirable to prevent this vehicle data from being provided to service provider without the user's permission, and to provide it in a secure mechanism with the user's permission.

In addition, when vehicle data is transmitted from a server that manages the vehicle data to a server that provides a service, communication for authentication is first performed mutually between the servers, and it is desirable to transmit the vehicle data simply while having a secure mechanism. However, PTL 1 does not disclose how to transmit vehicle data simply while having a secure mechanism.

Therefore, as a further improvement, the inventors of the present application conducted intensive research into how to realize a mobile object and the like that can easily transmit vehicle data while having a secure mechanism, and have devised the mobile object and the like described below.

The following describes an embodiment in detail with reference to the drawings.

It should be noted that the embodiments described below are all comprehensive or specific examples. The numerical values, shapes, components, arrangement positions and connection forms of the components, steps, order of steps, and the like shown in the following embodiments are merely examples and are not intended to limit the present disclosure. In addition, among the components in the following embodiments, the components that are not described in the independent claims are described as arbitrary components.

In addition, each figure is a schematic diagram and is not necessarily an exact illustration. Therefore, for example, the scale and the like do not necessarily match among the figures. In addition, in each figure, substantially identical configurations are given the same reference numerals, and duplicate explanations are omitted or simplified.

In addition, in the present specification, numerical values and numerical ranges are not expressions that only express a strict meaning, but are expressions that means a substantially equivalent range, for example, including a difference of about a few percent (or about 10%).

In addition, in the present specification, unless otherwise specified, ordinal numbers such as “first” and “second” do not mean the number or order of components, but are used for the purpose of avoiding confusion between and distinguishing between components of the same type.

### Embodiment

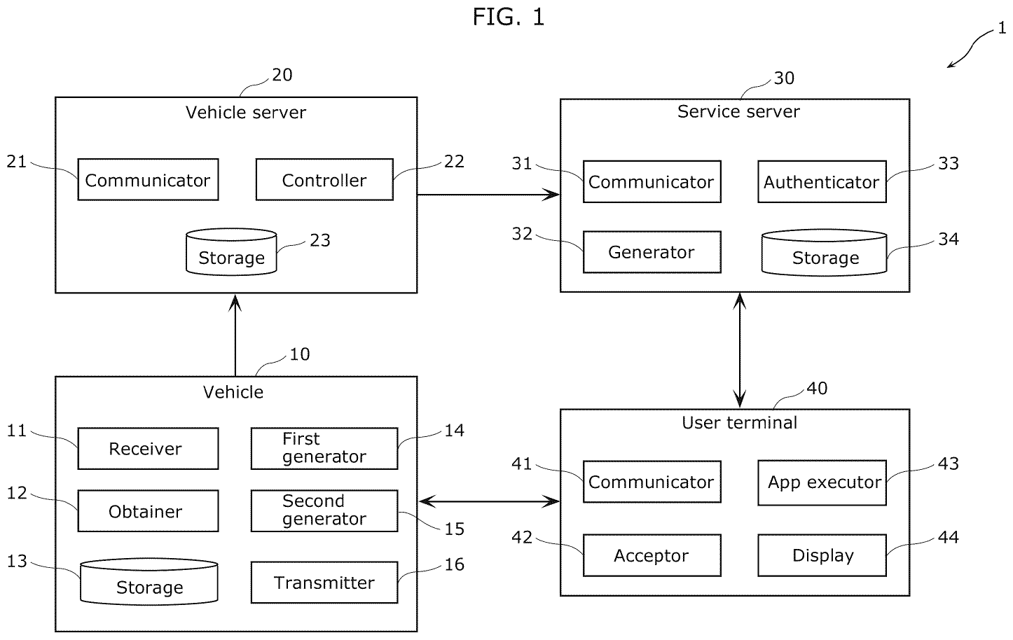

A mobile object, an authentication system including the mobile object, and the like according to the present embodiment will be described below with reference to FIG. 1 to FIG. 10.

### [1. Configuration of Authentication System]

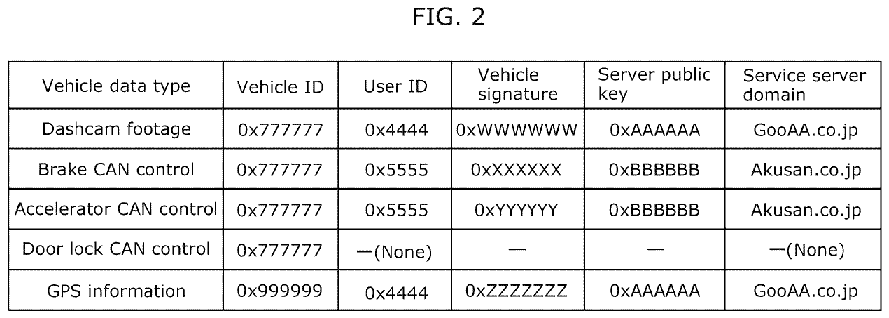

First, the configuration of a mobile object and an authentication system including the mobile object according to the present embodiment will be described with reference to FIG. 1 and FIG. 2. FIG. 1 is a block diagram showing the functional configuration of authentication system 1 according to the present embodiment. Authentication system 1 according to the present embodiment is a system for easily providing vehicle data collected by vehicle server 20 to service server 30 operated by a third party operator, which is different from vehicle server 20. It should be noted that in the following, an example of authentication system 1 including vehicle 10, which is an example of a mobile object, will be described.

As shown in FIG. 1, authentication system 1 includes vehicle 10, vehicle server 20, service server 30, and user terminal 40. Vehicle 10 and vehicle server 20, and vehicle 10 and user terminal 40 are communicatively connected, vehicle server 20 and service server 30 are communicatively connected, and service server 30 and user terminal 40 are communicatively connected.

Vehicle 10 is a vehicle used by a user. Vehicle 10 may be a manually driven vehicle driven by a user, a fully automated vehicle not driven by a user, or a vehicle capable of switching between manual and automated driving. In addition, vehicle 10 may be a vehicle owned by a user, a rental vehicle, or a vehicle used for car sharing.

Vehicle 10 includes receiver 11, obtainer 12, storage 13, first generator 14, second generator 15, and transmitter 16. Vehicle 10 includes a processor, a memory, and the like. The memory is a read only memory (ROM), a random access memory (RAM), and the like, and can store a program executed by the processor. First generator 14 and second generator 15 are realized by a processor or the like that executes a program stored in the memory.

Receiver 11 is a communication interface for receiving information used for authentication performed by service server in the present embodiment. Receiver 11 receives first authentication information from service server 30 for providing a service which the user of vehicle 10 has contracted. The first authentication information includes user identification information (e.g., a user ID) and a public key of service server (server public key). Receiver 11 is configured to include, for example, a communication circuit (communication module). The server public key is an example of the first public key.

Obtainer 12 is an interface for obtaining user-related vehicle data. Obtainer 12 obtains vehicle control data (control data for travelling, turning, stopping, and the like) obtained by the user's driving, the user's biometric information, camera footage of the user, route information (transmission destination, driving route), and the like as vehicle data. Obtainer 12 obtains vehicle data, for example, from various sensors provided in the vehicle. Vehicle data is an example of mobile object data.

Storage 13 is a storage device capable of storing various information used for authentication performed by service server in the present embodiment. Storage 13 stores, for example, information transmitted by service server 30. Specifically, storage 13 stores first authentication information received by receiver 11. In addition, storage 13 stores, for example, information generated by first generator 14. Specifically, storage 13 stores a public key (vehicle public key) and a vehicle signature that are generated by first generator 14. In addition, storage 13 stores a vehicle ID indicating identification information of vehicle 10. The vehicle public key is an example of a second public key, the vehicle ID and the vehicle public key are examples of second authentication information, and the vehicle ID and the vehicle signature are examples of third authentication information.

In addition, storage 13 stores a private key (vehicle private key). The vehicle private key may be generated corresponding to a vehicle ID, for example. The vehicle private key is generated, for example, when vehicle 10 is manufactured, and stored in storage 13. The vehicle private key is stored in storage 13, for example, when vehicle 10 is shipped from the factory. Storage 13 is realized, for example, by a semiconductor memory, but is not limited thereto. The vehicle private key is an example of a second private key.

First generator 14 generates information used for authentication performed by service server 30 in the present embodiment. First generator 14 generates a vehicle public key that is paired with the vehicle private key. In addition, first generator 14 further generates a signature (vehicle signature) of vehicle 10 by using the pre-stored vehicle private key. First generator 14 may generate the vehicle signature by encrypting at least one of the vehicle ID, the user ID, the service server domain, or the vehicle data, or information based on the at least one of them (e.g., the at least one hash value), by using the vehicle private key. First generator 14 may generate the vehicle signature by encrypting, for example, at least two or all of the vehicle ID, the user ID, the service server domain, or the vehicle data, or information based on the at least two or all of them (e.g., the at least two or all hash values), by using the vehicle private key. In addition, first generator 14 may generate the vehicle signature, for example, by using at least information pre-stored by vehicle 10, such as the vehicle ID, or information generated by vehicle 10, such as the vehicle data. When placing importance on security (integrity), the amount of information used in the vehicle signature may be increased, and when placing importance on availability, the amount of information used in the vehicle signature may be decreased compared to when placing importance on security (integrity).

First generator 14 is an example of a generator, and the vehicle signature is an example of a second signature.

Second generator 15 generates vehicle data to which the first authentication information from service server 30 and the third authentication information of vehicle 10 have been added.

FIG. 2 is a diagram showing an example of authentication information to be added to vehicle data in the present embodiment. FIG. 2 shows the correspondence relationship between vehicle data and authentication information linked to the vehicle data. The authentication information includes a vehicle ID, a user ID, a vehicle signature, and a server public key. The authentication information may further include a service server domain.

The vehicle data type indicates the type of vehicle data. The vehicle data type includes, for example, dashcam video (video from a drive recorder), brake control area network (CAN) control, accelerator CAN control, door lock CAN control, and global positioning system (GPS) information.

The brake CAN control, accelerator CAN control, and door lock CAN control include log information related to the contents of frames (messages) to the electronic controller (ECU) that controls the brakes, the ECU that controls the accelerator, and the ECU that controls the door locks, which are transmitted over the CAN bus included in the in-vehicle network, the timing of reception, and the like.

The vehicle ID indicates the identification information of the vehicle used by the user. A different vehicle ID means that vehicle 10 used by the user is different.

The user ID indicates the identification information of a user who has contracted with service server 30. When one user has contracted with different service servers 30, a different user ID is issued for each service server 30. For example, the user IDs “0x4444” and “0x5555” shown in FIG. 2 are IDs for the same user, but are user IDs issued by different service servers 30.

The vehicle signature indicates a signature generated using a vehicle private key generated by first generator 14 of vehicle 10. A different vehicle signature means either that service server 30 with which the user has a contract is different, or that vehicle 10 is different.

The server public key indicates a public key generated by service server 30. A different server public key means that the user has a contract with different service server 30.

The service server domain indicates the transmission destination address of service server 30 that uses that vehicle data. A different service server domain means that the user has a contract with different service server 30.

As shown in FIG. 2, for example, when dashcam footage, which is an example of vehicle data, is transmitted to vehicle server 20, second generator 15 adds the vehicle ID “0x777777,” user ID “0x4444,” vehicle signature “0xWWWWWW,” server public key “0xAAAAAA,” and service server domain “GooAA.co.jp” as authentication information to the dashcam footage and transmits it to vehicle server 20. The dashcam footage is used by that service server 30 (service provider) to which the user has contracted and which has issued the server public key “0xAAAAAA.”

In addition, as shown in FIG. 2, for example, when brake CAN control, which is an example of vehicle data, is transmitted to vehicle server 20, second generator 15 adds the vehicle ID “0x777777”, user ID “0x5555”, vehicle signature “0xXXXXXX”, server public key “0xBBBBBB”, and service server domain “Akusan.co.jp” as authentication information to the brake CAN control and transmits it to vehicle server 20. The brake CAN is used by that service server 30 (service provider) to which the user has contracted and which has issued the server public key “0xBBBBBB.” That is, the dashcam footage and the brake CAN control are used by different service servers 30.

It should be noted that “-(None)” shown in FIG. 2 indicates that no information is added to the vehicle data. When the door lock CAN control is transmitted to vehicle server 20, second generator 15 transmits the door lock CAN control to vehicle server 20 without adding authentication information. In this case, vehicle server 20 does not transfer the door lock CAN control to service server 30.

Referring again to FIG. 1, transmitter 16 is a communication interface for transmitting vehicle data to vehicle server 20. Transmitter 16 transmits the vehicle data, to which the first authentication information and the third authentication information have been added, to vehicle server 20. Transmitter 16 may further add information indicating the transmission destination of service server 30 (e.g., a service server domain) to the vehicle data before transmitting it.

Vehicle server 20 is a server that collects vehicle data. Vehicle server 20 may be realized by a cloud server. In addition, vehicle server 20 is a server operated by the OEM that manufactures and sells vehicle 10 (or an OEM affiliated company). Vehicle server 20 is an example of a second server.

Vehicle server 20 includes communicator 21, controller 22, and storage 23. Vehicle server 20 includes a processor, a memory, and the like. The memory is a ROM, a RAM, or the like, and can store programs executed by the processor. Controller 22 is realized by a processor or the like that executes programs stored in the memory.

Communicator 21 is a communication interface for vehicle server 20 to communicate with vehicle 10 and service server 30. Communicator 21 receives vehicle data to which authentication information has been added from vehicle 10. In addition, communicator 21 transfers the vehicle data, to which authentication information received from vehicle 10 has been added, to service server 30. Communicator 21 is configured to include, for example, a communication circuit (communication module).

Controller 22 is a control device that controls each component of vehicle server 20. Controller 22 executes a process for transferring the vehicle data, to which the authentication information received from vehicle 10 via communicator 21 has been added, to service server 30 via communicator 21. When the authentication information includes a service server domain, controller 22 transfers the vehicle data, to which the authentication information has been added, to a transmission destination address indicated by the service server domain.

Storage 23 stores vehicle data and the like to which the authentication information received from vehicle 10 has been added. Storage 23 is realized, for example, by a semiconductor memory, but is not limited thereto.

Service server 30 is a server for providing a third-party service (a service that utilizes vehicle data) that the user has contracted. The service is not particularly limited, but may be, for example, a service that determines the insurance premium for the car insurance that the user contracts based on the vehicle data. Service server 30 may be realized by a cloud server. In addition, service server 30 is a server operated by a service provider that provides the service that the user has contracted. Service server 30 is an example of a first server.

Service server 30 includes communicator 31, generator 32, authenticator 33, and storage 34. Service server 30 includes a processor, a memory, and the like. The memory is a ROM, a RAM, or the like, and can store a program executed by the processor. Generator 32 and authenticator 33 are realized by a processor or the like that executes a program stored in the memory.

Communicator 31 is a communication interface for service server 30 to communicate with vehicle server 20 and user terminal 40. Communicator 31 receives vehicle data, to which authentication information has been added, from vehicle server 20. In addition, communicator 31 receives information related to the user contract and second authentication information from user terminal 40. In addition, communicator 31 transmits, to user terminal 40, first authentication information including a user ID and a server public key generated by generator 32 after the contract has been made. Communicator 31 is configured to include, for example, a communication circuit (communication module).

Generator 32 generates information used for authentication performed by service server 30 in the present embodiment. Generator 32 generates a user ID of a contracted user and a server public key that pairs with a private key (server private key) pre-stored in storage 34. In addition, generator 32 further generates a signature (server signature) of service server 30 using the server private key. Generator 32 generates the server signature, for example, by encrypting the user ID or a hash value of the user ID with the server private key. The server private key is an example of a first private key, and the server signature is an example of a first signature.

Authenticator 33 executes an authentication operation when communicator 31 receives vehicle data, to which authentication information has been added, from vehicle server 20. Authenticator 33 executes service server authentication and user authentication based on the authentication information added to the vehicle data and the user ID, server signature, vehicle ID, and vehicle public key that are stored in storage 34.

Service server authentication is authentication as to whether the vehicle data is linked to a user who has a contract with the service provider that operates service server 30. User authentication is authentication as to whether the vehicle data is data from vehicle 10 that the user has given permission to use.

Storage 34 is a storage device capable of storing various information used for authentication performed by service server in the present embodiment. Storage 34 stores, for example, information generated by generator 32. Specifically, storage 34 stores a user ID, a server public key, and a server signature. In addition, storage 34 stores, for example, information transmitted from vehicle 10 and received via user terminal 40. Specifically, storage 34 stores a vehicle ID and a vehicle public key that have been received via communicator 31. The user ID and server public key are examples of first authentication information, and the user ID and server signature are examples of fourth authentication information.

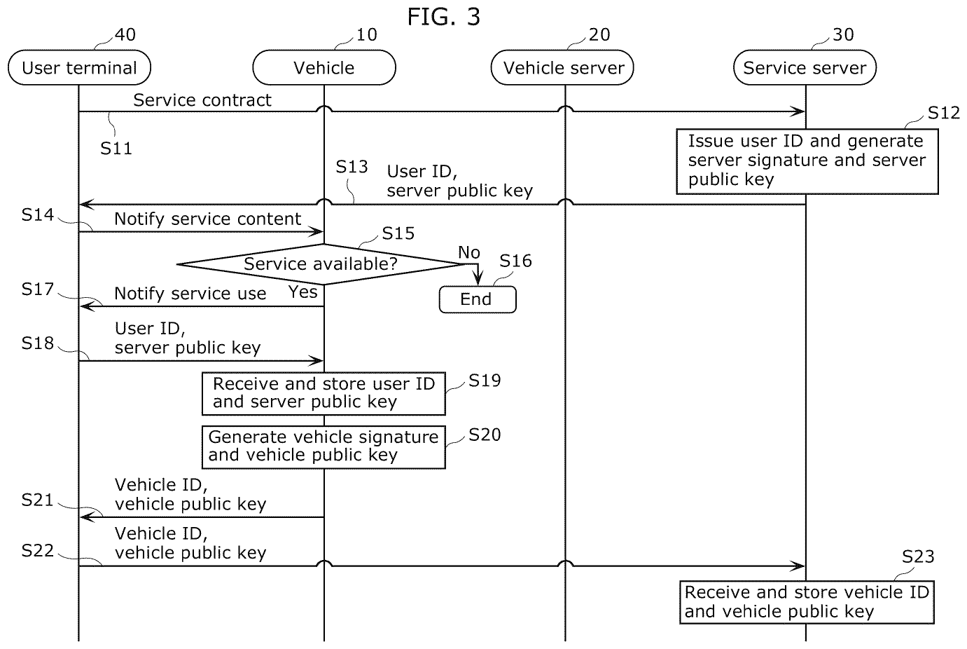

In addition, storage 34 stores a server private key. The server private key is, for example, generated in advance and stored in storage 34. The server private key is stored in storage 34, for example, before the process of step S11 shown in FIG. 3 described below is executed. Storage 34 is realized, for example, by a semiconductor memory, but is not limited thereto.

User terminal 40 is a terminal device carried by a user who uses vehicle 10. User terminal 40 may be, for example, a portable terminal device such as a smartphone or a tablet, or a stationary terminal device such as a personal computer (PC).

User terminal 40 includes communicator 41, acceptor 42, app executor 43, and display 44. User terminal 40 includes a processor, a memory, and the like. The memory is a ROM, a RAM, or the like, and can store a program to be executed by the processor. App executor 43 is realized by a processor or the like that executes a program stored in the memory.

Communicator 41 is a communication interface for user terminal 40 to communicate with vehicle 10 and service server 30. Communicator 41 transmits information relating to the contract obtained by user input to service server 30, receives first authentication information from service server 30, and transmits the received first authentication information to vehicle 10. In addition, communicator 41 receives second authentication information from vehicle 10 and transmits it to service server 30. Communicator 41 is configured to include, for example, a communication circuit (communication module).

Acceptor 42 accepts operations, selections, and the like from the user. Acceptor 42 accepts, from the user, inputs related to the contract, inputs indicating whether the service can be used, and the like. Acceptor 42 is realized by, for example, a button, a touch panel, a sound collection device, or the like, but is not limited thereto.

App executor 43 is a processing unit that executes a downloaded application (hereinafter, also referred to as an app). The app may be a dedicated app for receiving a service from service server 30.

Displayer 44 displays predetermined information to the user. For example, display 44 displays an input screen related to a contract, an input screen for availability, and the like. Displayer 44 is configured to include, for example, a display panel such as a liquid crystal display panel.

### [2. Operation of the Authentication System]

Subsequently, the operation of authentication system 1 configured as described above will be described with reference to FIG. 3 to FIG. 10. FIG. 3 is a first sequence diagram showing the operation (information processing method) of authentication system 1 according to the present embodiment. The process shown in FIG. 3 is executed before the user uses vehicle 10 or before vehicle 10 is driven. In addition, the operation of user terminal 40 may be executed via an app.

As shown in FIG. 3, first, communicator 41 of user terminal 40 transmits a service contract for receiving a service to service server 30 (S11). The contents of the service contract include, for example, contents based on information having been accepted from the user by acceptor 42.

Next, when communicator 31 receives the service contract, generator 32 of service server 30 issues a user ID and generates a server signature and a server public key (S12). Generator 32 executes user registration and issues a user ID. In addition, generator 32 generates a server signature using the server private key, and generates a server public key. The server public key is a public key that is generated individually for each user. It should be noted that any known method may be used to generate the public key.

Next, communicator 31 of service server 30 transmits the user ID and the server public key to user terminal 40 (S13). Upon receiving the user ID and the server public key from service server 30 via communicator 41, user terminal 40 stores them, for example, in a storage (not shown). It should be noted that at this point, user terminal 40 and vehicle 10 may be in a state in which communication is not possible.

Next, when the vehicle is used (for example, after the ignition is turned on and user terminal 40 and vehicle 10 are able to communicate), communicator 41 of user terminal 40 transmits a service content notification corresponding to service server 30 to vehicle 10 (S14).

Next, vehicle 10 determines whether the service is available (S15). The user is prompted to determine whether the vehicle data obtained by that vehicle 10 may be used to provide the service (i.e., whether the vehicle data may be transferred to service server 30), and the determination in step S15 is performed by obtaining the result of the determination. If vehicle 10 obtains an input from the user indicating that the vehicle data of that vehicle 10 will not be used to provide the service, vehicle 10 determines that the service is unavailable (No in S15) and terminates the process (S16), whereas if vehicle obtains an input from the user indicating that the vehicle data of vehicle 10 will be used to provide the service, vehicle 10 determines that the service is available (Yes in S15) and proceeds to step S17. “Available” means that vehicle server 20 is permitted to transfer the vehicle data to service server 30.

It should be noted that The service here refers to a service that uses each vehicle data related to the user in vehicle 10 (for example, the determination of insurance premiums as exemplified above). In addition, the input indicating whether to use the service may be, for example, a user input (for example, a touch operation) to a navigation system or the like provided in vehicle 10.

Next, if the service is available, transmitter 16 of vehicle transmits a service usage notification to user terminal 40 indicating that the service will be used (S17).

Next, when communicator 41 of user terminal 40 receives the service usage notification, it transmits the user ID and server public key that have been obtained from service server 30 to vehicle 10 (S18).

Next, receiver 11 of vehicle 10 receives the user ID and the server public key, and stores the received user ID and server public key in storage 13 (S19). Accordingly, vehicle 10 will store information for performing service server authentication.

Next, upon obtaining the user ID and server public key, first generator 14 of vehicle 10 generates a vehicle signature and a vehicle public key (S20). The vehicle signature and the vehicle public key are generated by first generator 14 in correspondence with the user ID generated by service server 30. In other words, the vehicle public key and the vehicle signature are generated in correspondence with the user ID. In addition, the vehicle signature and vehicle public key are, for example, information unique to that service server 30, and if there are a plurality of service servers 30, different vehicle signatures and vehicle public keys are generated for each service server 30. The vehicle public key is used in service server 30 to verify whether the vehicle signature is legitimate.

Next, transmitter 16 transmits the vehicle ID stored in storage 13 and the vehicle public key generated by first generator 14 to user terminal 40 (S21).

Next, upon receiving the vehicle ID and the vehicle public key from transmitter 16, communicator 41 of user terminal 40 transmits them to service server 30 (S22).

Next, communicator 31 of service server 30 receives the vehicle ID and vehicle public key, and stores the received vehicle ID and vehicle public key in storage 34 (S23). Accordingly, service server 30 will store information for user authentication. If the user allows the use of the vehicle data of that vehicle 10, service server 30 will have the vehicle ID and vehicle public key.

In this way, in order to easily provide vehicle data to service server 30, a user ID and server public key, and a vehicle ID and vehicle public key are exchanged in advance between vehicle 10 and service server 30. In other words, a state is created in advance in which vehicle 10 stores the user ID and server public key, and service server 30 stores the vehicle ID and vehicle public key. “In advance” means before the user uses vehicle 10.

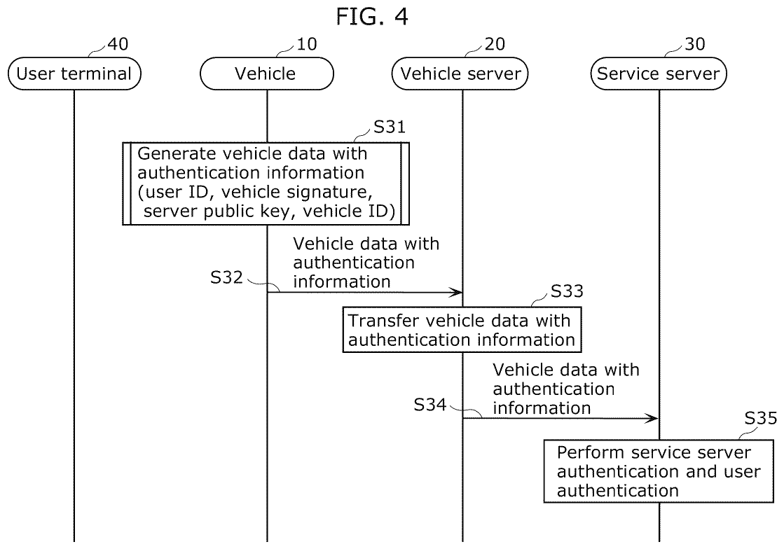

Subsequently, the operation of transferring vehicle data and performing authentication will be described with reference to FIG. 4 to FIG. 10. FIG. 4 is a second sequence diagram showing the operation (information processing method) of authentication system 1 according to the present embodiment.

As shown in FIG. 4, second generator 15 of vehicle 10 generates vehicle data to which authentication information (user ID, vehicle signature, server public key, vehicle ID) has been added (S31).

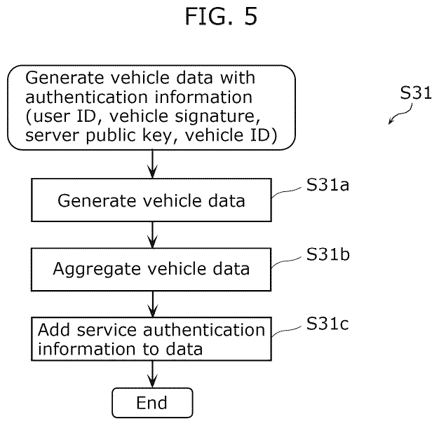

FIG. 5 is a flowchart showing details of the operation (information processing method) of step S31 shown in FIG. 4.

As shown in FIG. 5, second generator 15 generates vehicle data to be used for a service determined by the user to be available by obtaining the vehicle data from various sensors and the like (S31a). The vehicle data may include, for example, time series data measured by the various sensors.

It should be noted that the timing of generating the vehicle data is not particularly limited. For example, the vehicle data may be generated periodically, intermittently, or on an ongoing basis. “Intermittently” means that the vehicle data is generated periodically, and the interval at which the vehicle data is generated is shorter than a predetermined interval. “On an ongoing basis” means that the vehicle data is generated every time an irregular event occurs.

Next, second generator 15 aggregates the vehicle data (S31b) and adds service authentication information (authentication information) to the vehicle data (data) (S31c). The aggregation may involve combining all of the plurality of data into one (to make one vehicle data), or may involve thinning out some of the plurality of data and combining them into one.

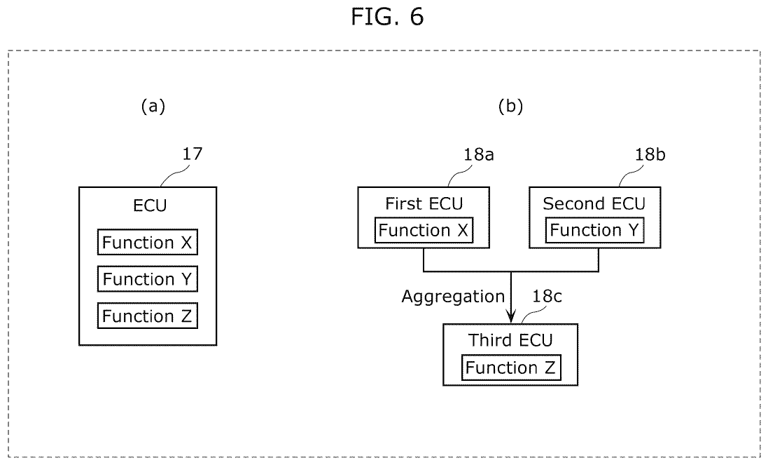

FIG. 6 is a diagram to explain the aggregation of vehicle data.

As shown in (a) in FIG. 6, when one ECU 17 includes a plurality of functions (functions X, Y, and Z), vehicle data is generated and aggregated within that ECU 17. ECU 17 adds authentication information to the aggregated vehicle data.

It should be noted that functions X, Y, and Z are different functions from one another. For example, function X may be a function for transmitting frames (messages) via a CAN bus, function Y may be a function for capturing video data, and function Z may be a function for storing the occurrence of a predetermined vehicle event.

As shown in (b) in FIG. 6, when functions are distributed among a plurality of ECUs (e.g., first ECU 18a, second ECU 18b, and third ECU 18c), respectively, vehicle data may be generated and aggregated in each ECU, for example. Furthermore, vehicle data collected by each ECU may be aggregated in one ECU. For example, each of first ECU 18a, second ECU 18b, and third ECU 18c may perform aggregation, and the aggregated vehicle data may be aggregated in third ECU 18c. In this case, the vehicle data of first ECU 18a and second ECU 18b will be transmitted collectively by third ECU 18c to vehicle server 20. It should be noted that each of first ECU 18a, second ECU 18b, and third ECU 18c may add authentication information to its own vehicle data, and the vehicle data to which the authentication information has been added may be aggregated in third ECU 18c, or vehicle data to which no authentication information has been added may be aggregated in third ECU 18c, and third ECU 18c may add authentication information to each vehicle data.

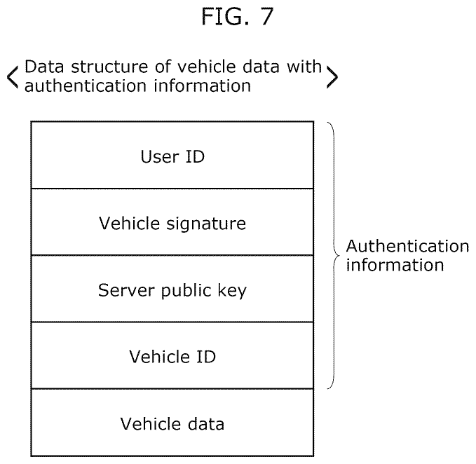

FIG. 7 is a diagram showing a first example of the data structure of vehicle data to which authentication information has been added in the present embodiment.

As shown in FIG. 7, the vehicle data generated in step S31c includes authentication information and vehicle data. In the example of FIG. 7, the authentication information includes a user ID, a vehicle signature, a server public key, and a vehicle ID. In addition, the vehicle data may further include a service server domain.

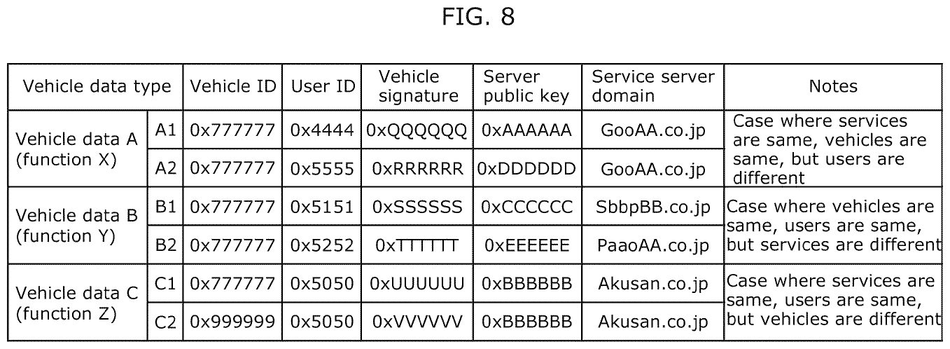

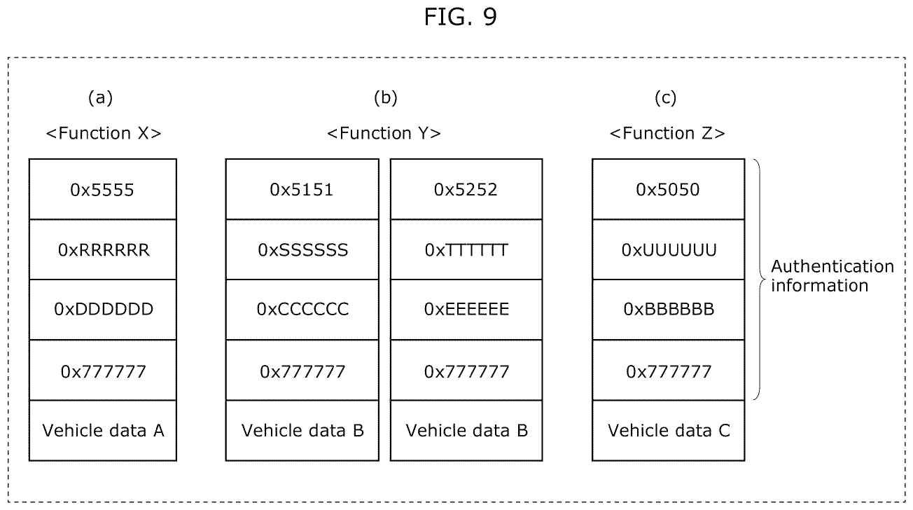

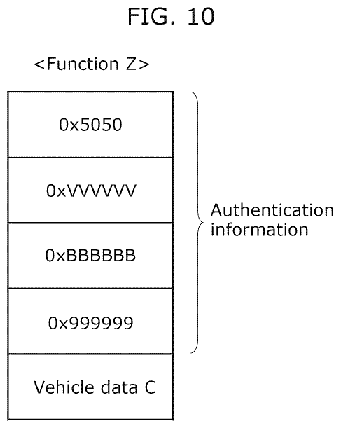

Other examples of the authentication information to be added will now be described with reference to FIG. 8 to FIG. 10. FIG. 8 is a diagram showing another example of authentication information to be added to vehicle data. FIG. 9 and FIG. 10 are diagrams showing examples of data structures of vehicle data to which authentication information according to the present embodiment has been added. The authentication information shown in FIG. 9 and FIG. 10 is written in the order of user ID, vehicle signature, server public key, and vehicle ID from the top (the same order as in FIG. 7).

FIG. 8 shows an example in which two types of authentication information are associated with each vehicle data type.

The vehicle data type includes vehicle data A obtained by function X (see (b) in FIG. 6), vehicle data B obtained by function Y (see (b) in FIG. 6), and vehicle data C obtained by function Z (see (b) in FIG. 6).

As indicated in the notes, A1 and A2 of vehicle data A show examples of authentication information that is added when the services are the same, vehicles 10 are the same, but the users are different. In this case, since vehicles 10 are the same, the vehicle ID and vehicle signature are common, and since the services are the same (service servers 30 are the same), the service server domain is also common. Different information is set for each user as the user ID and server public key, so the information will be different for different users.

(a) in FIG. 9 shows the data structure of authentication information for A2 of vehicle data A. As shown in (a) in FIG. 9, user ID “0x5555”, vehicle signature “0xRRRRRR”, server public key “0xDDDDDD”, and vehicle ID “0x777777” are added to vehicle data A as authentication information.

Referring again to FIGS. 8, B1 and B2 of vehicle data B show examples of authentication information added in such a case that vehicles are the same, users are the same, but services are different, as indicated in the notes. In this case, since vehicles are the same, the vehicle ID and vehicle signature are common. The user ID and server public key will be different information even for the same user if the service (service server that issues the user ID) is different. In addition, because the service (service server 30) is different, the service server domain is also different.

(b) in FIG. 9 shows the data structure of authentication information for B1 and B2 of vehicle data B. As shown in (b) in FIG. 9, the user ID “0x5151”, vehicle signature “0xSSSSSS”, server public key “0xCCCCCC”, and vehicle ID “0x777777” are added to vehicle data B (B1) transmitted to the service server domain “SbbpBB.co.jp” as authentication information. In addition, as shown in (b) in FIG. 9, the user ID “0x5252”, vehicle signature “0xTTTTTT”, server public key “0xEEEEEE”, and vehicle ID “0x777777” are added to vehicle data B (B2) transmitted to the service server domain “PaaoAA.co.jp” as authentication information.

Referring again to FIGS. 8, C1 and C2 of vehicle data C show examples of authentication information added in such a case that services are the same, users are the same, but vehicles are different, as indicated in the notes. In this case, since the user and service (service server 30) are the same, the user ID, server public key, and service server domain are common. Different information is set for the vehicle ID and vehicle signature for each vehicle 10, so the information will be different for different vehicles.

(c) in FIG. 9 shows the data structure of authentication information for C1 of vehicle data C. As shown in (c) in FIG. 9, the user ID “0x5050”, vehicle signature “0xUUUUUU”, server public key “0xBBBBBB”, and vehicle ID “0x777777” are added to vehicle data C (C1) transmitted from vehicle ID “0x777777” as authentication information.

FIG. 10 shows the data structure of authentication information for C2 of vehicle data C. As shown in FIG. 10, the user ID “0x5050”, vehicle signature “0xVVVVVV”, server public key “0xBBBBBB”, and vehicle ID “0x999999” are added to vehicle data C (C2) transmitted from vehicle ID “0x999999” as authentication information.

Referring again to FIG. 4, transmitter 16 of vehicle 10 transmits the vehicle data, to which the authentication information has been added, to vehicle server 20 (S32). The authentication information includes a user ID, a vehicle signature, a server public key, and a vehicle ID. In this way, since the user ID is added to the vehicle data, the vehicle data is transmitted to vehicle server 20 as information linked to the user. It should be noted that if the service is not available, no authentication information is added and only the vehicle data is transmitted.

When communicator 21 of vehicle server 20 receives the vehicle data to which the authentication information transmitted from transmitter 16 has been added, it transfers the vehicle data, to which the received authentication information has been added, to service server 30 (S33). Communicator 21 transfers the vehicle data, to which the authentication information has been added, to service server 30 without performing an authentication operation between vehicle server 20 and service server 30. Accordingly, the vehicle data, to which the authentication information has been added, is transmitted from vehicle server 20 to service server 30 (S34).

It should be noted that controller 22 of vehicle server 20 may store the received vehicle data in storage 23. In addition, after the vehicle data to which the authentication information has been added is transmitted to vehicle server 20, the authentication information of the vehicle data stored in storage 23 may be deleted except for the vehicle ID.

Next, authenticator 33 of service server 30 performs service server authentication and user authentication based on the authentication information added to the received vehicle data and the user ID, server signature, vehicle ID and vehicle public key obtained in advance and stored in storage 34 (S35). Authenticator 33 performs user authentication based on the user ID and server public key included in the authentication information and the user ID and server signature stored in storage 34 of service server 30. In addition, authenticator 33 performs service server authentication based on the vehicle ID and vehicle signature included in the authentication information and the vehicle ID and vehicle public key stored in storage 34 of service server 30.

Authenticator 33 verifies whether the server signature stored in storage 34 can be decrypted using the server public key added to the vehicle data. If authenticator 33 can decrypt the server signature with the server public key, it determines that the server public key is legitimate (e.g., the vehicle data is linked to a user), and if authenticator 33 cannot decrypt the server signature with the server public key, it determines that that server public key is illegitimate (e.g., the vehicle data is not linked to a user). In this way, the server signature makes it possible to verify whether the server public key is legitimate.

In addition, authenticator 33 may verify whether the user ID added to the vehicle data matches the user ID stored in storage 34.

Authenticator 33 verifies whether the vehicle signature added to the vehicle data can be decrypted with the vehicle public key stored in storage 34. If authenticator 33 can decrypt the vehicle signature with the vehicle public key, it determines that the vehicle signature is legitimate (e.g., the vehicle data is from vehicle 10 whose use has been permitted by the user), and if authenticator 33 cannot decrypt the vehicle signature with the vehicle public key, it determines that the vehicle signature is illegitimate (e.g., the vehicle data is not from vehicle 10 whose use has been permitted by the user). In this way, the vehicle public key can verify whether the vehicle signature is legitimate.

In addition, authenticator 33 may verify whether the vehicle ID added to the vehicle data matches the vehicle ID stored in storage 34.

If the user authentication and service server authentication are successful, service server 30 uses the received vehicle data to provide the user with specified services.

As described above, by including the user ID, vehicle ID, vehicle signature, and server public key in the vehicle data, even if the user changes vehicle 10 for use, it is possible to transmit vehicle data to which authentication information has been added to service server 30. Accordingly, for example, even if vehicles 10 are different, as long as the users are the same, service server 30 can centrally manage the vehicle data as the user's vehicle data.

### Variations of the Embodiment

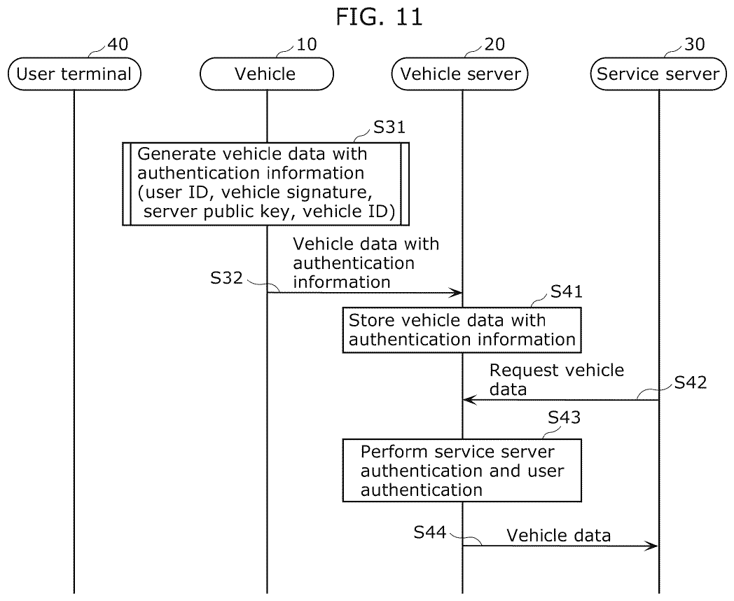

Hereinafter, the authentication system according to the present variation will be described with reference to FIG. 11. It should be noted that the following description will focus on the differences from the embodiment, and description of the same or similar content as in the embodiment will be omitted or simplified. It should be noted that the authentication system according to the present variation differs from authentication system 1 according to the embodiment in that vehicle server 20 includes authenticator 33. The following description will use the reference numerals of authentication system 1 according to the embodiment.

FIG. 11 is a sequence diagram showing the operation (information processing method) of the authentication system according to the present variation.

As shown in FIG. 11, when vehicle server 20 receives the vehicle data, to which the authentication information has been added, from vehicle 10, vehicle server 20 stores the vehicle data to which the authentication information has been added (S41). Controller 22 stores the vehicle data, to which the authentication information received via communicator 21 has been added, in storage 23.

Next, communicator 31 of service server 30 requests vehicle data from vehicle server 20 (S42). Communicator 31 may add the user ID, server signature, vehicle ID, and vehicle public key stored in storage 34 to the vehicle data and transmit it to vehicle server 20. It should be noted that the request for vehicle data may be executed periodically, or at a timing determined according to the type of service.

Next, an authenticator (not shown) of vehicle server 20 has the same function as authenticator 33 according to the embodiment, and when it receives the request for vehicle data, it performs service server authentication and user authentication (S43). The process of step S43 is the same as step S35 shown in FIG. 4.

Next, if the service server authentication and user authentication by the authenticator are successful, communicator 21 of vehicle server 20 transmits the vehicle data to service server 30 (S44). Authentication information may not be added to the vehicle data transmitted here. In other words, vehicle server 20 may remove the authentication information and transmit only the vehicle data to service server 30.

Even when such authentication operations are performed by vehicle server 20, it is possible to realize vehicle 10 and the like that can easily transmit vehicle data to service server 30 while having a secure mechanism.

### OTHER EMBODIMENTS

While the mobile object and the like according to one or more aspects have been described above based on the embodiment and the like, the present disclosure is not limited to this embodiment and the like. Forms obtained by applying various modifications to the present embodiment conceived by a person skilled in the art or forms constructed by arbitrarily combining the components in different embodiments without departing from the spirit of the present disclosure may also be included in the present disclosure.

For example, in the above embodiment and the like, an example has been described in which when the vehicle transmits vehicle data to the vehicle server, the vehicle adds information indicating the transmission destination of the service server to the vehicle data, but this is not limited thereto. For example, if there is only one service server to which the vehicle data is to be transmitted, such as when the user has contracted only one service, the vehicle may not add information indicating the transmission destination of the service server to the vehicle data. In this case, for example, the vehicle server may store information indicating the transmission destination of the service server.

In addition, in the above embodiment and the like, a vehicle is exemplarily described as an example of a mobile object, but the mobile object is not limited to a vehicle. The mobile object may be a train, a ship, an air vehicle such as a drone, or the like.

In addition, in FIG. 3 in the above embodiment, the vehicle ID and vehicle public key, and the user ID and server public key are exchanged between vehicle 10 and service server 30, but the information exchanged may be only one of the vehicle ID and vehicle public key, and the user ID and server public key. In this case, only one of the service server authentication and user authentication shown in FIG. 4 is executed.

In addition, in the above embodiment and the like, a user ID and a server public key are given as examples of the first authentication information, but the first authentication information may be other information as long as it is information that can generate a vehicle signature in the vehicle. In addition, a vehicle ID and a vehicle public key are given as examples of the second authentication information, but the second authentication information may be other information that can perform authentication. In addition, a vehicle ID and a vehicle signature are given as examples of the third authentication information, but the third authentication information may be other information that can perform authentication using the second authentication information. In addition, a user ID and a server signature are given as examples of the fourth authentication information, but the fourth authentication information may be other information that can perform authentication using the first authentication information.

In addition, in the above embodiment and the like, each component may be configured with dedicated hardware, or may be realized by executing a software program suitable for each component. Each component may be realized by a program executor such as a CPU or processor reading and executing a software program recorded on a recording medium such as a hard disk or semiconductor memory.

In addition, the order in which each step in the flowchart is executed is merely an example for specifically explaining the present disclosure, and it may be an order other than the above. In addition, some of the steps may be executed simultaneously (in parallel) with other steps, or some of the steps may not be executed.

In addition, the division of functional blocks in a block diagram is one example, and a plurality of functional blocks may be realized as one functional block, one functional block may be divided into a plurality of blocks, or some functions may be transferred to other functional blocks. In addition, the functions of a plurality of functional blocks having similar functions may be processed in parallel or in a time-sharing manner by a single piece of hardware or software.

In addition, at least one of the vehicle server or the service server in the above embodiment and the like may be realized as a single device, or may be realized by a plurality of devices. When at least one of the vehicle server or the service server is realized by a plurality of devices, the components included in at least one of the vehicle server or the service server may be allocated in any manner to the plurality of devices. When at least one of the vehicle server or the service server is realized by a plurality of devices, the communication method between the plurality of devices is not particularly limited, and may be wireless communication or wired communication. In addition, wireless communication and wired communication may be combined between the devices.

In addition, each of the components described in the above embodiment and the like may be realized as software, or may be realized as an LSI, which is typically an integrated circuit. These may be individually integrated into one chip, or may be integrated into one chip to include some or all of them. Here, LSI is used, but depending on the degree of integration, it may be called IC, system LSI, super LSI, or ultra LSI. In addition, the method of circuit integration is not limited to LSI, and may be realized by a dedicated circuit (a general-purpose circuit that executes a dedicated program) or a general-purpose processor. A field programmable gate array (FPGA) to which programming is possible after an LSI has been manufactured or a reconfigurable processor that can reconfigure the connections or settings of circuit cells inside the LSI may be used. Furthermore, if an integrated circuit technology that replaces an LSI appears due to advances in semiconductor technology or another technology derived therefrom, it is natural that components may be integrated using that technology.

A system LSI is an ultra-multifunctional LSI manufactured by integrating a plurality of processing units onto a single chip, and specifically, is a computer system including a microprocessor, ROM, RAM, and the like. Computer programs are stored in the ROM. The system LSI achieves its functions by the microprocessor operating according to the computer programs.

In addition, one aspect of the present disclosure may be a computer program that causes a computer to execute each of the characteristic steps included in the information processing method shown in any of FIG. 3 to FIG. 5 and FIG. 11.

In addition, for example, the program may be a program to be executed by a computer. In addition, one aspect of the present disclosure may be a non-transitory computer-readable recording medium on which such a program is recorded. For example, such a program may be recorded on a recording medium and distributed or circulated. For example, by installing the distributed program in a device including another processor and having the program executed by that processor, it becomes possible to cause the device to perform each of the processes described above.

### (Additional Note)

The above description of the embodiments and the like discloses the following technologies.

### (Technology 1)

This is a mobile object (for example, vehicle 10) including: a receiver that receives first authentication information transmitted by a first server that stores second authentication information from the mobile object, the first server being for providing a service contracted by a user of the mobile object; an obtainer that obtains mobile object data of the mobile object; and a transmitter that transmits, to a second server that collects mobile object data, the mobile object data to which third authentication information and the first authentication information have been added, the third authentication information being information used for authentication using the second authentication information, wherein the first server stores fourth authentication information used for authentication using the first authentication information.

Accordingly, since the first authentication information and the third authentication information are added to the mobile object data, when the mobile object data is transferred from the second server to the first server, authentication can be performed in the first server using the first to third authentication information. Since authentication is performed using the first to fourth authentication information, a secure mechanism exists in the authentication system. In addition, the second server only needs to transfer the mobile object data, to which the first authentication information and the third authentication information have added, to the first server without communicating with the first server for authentication. Therefore, it is possible to realize a mobile object that can easily transmit mobile object data from the second server to the first server while having a secure mechanism.

### (Technology 2)

This is the mobile object according to technology 1, wherein the second authentication information includes identification information of the mobile object and a second public key of the mobile object, the second public key being paired with a second private key that is used to generate a second signature included in the third authentication information.

This makes it possible to perform authentication (for example, authentication as to whether the data is mobile object data from a mobile object that the user has authorized to use) based on whether the second signature included in the third authentication information can be decrypted using the second public key. This leads to having a secure mechanism.

### (Technology 3)

This is the mobile object according to technology 2, further including: a generator that generates the second public key and the second signature that is obtained by using the second private key of the mobile object.

This allows the generator of the mobile object to automatically generate the information required for authentication. This leads to easy transmission of mobile object data.

### (Technology 4)

This is the mobile object according to technology 3, wherein when the mobile object obtains the first authentication information, the generator generates the second public key and the second signature.

This makes it possible to generate a second public key and a second signature corresponding to the first authentication information.

### (Technology 5)

This is the mobile object according to any one of technologies 1 to 4, wherein the transmitter further adds information indicating a transmission destination of the first server to the mobile object data and transmits, to the second server, the mobile object data to which the information indicating a transmission destination has been added.

This allows the second server to transmit mobile object data to the first server even if it does not store the transmission destination of the first server.

### (Technology 6)

This is the mobile object according to any of technologies 1 to 5, wherein the fourth authentication information includes a first signature generated by using a first private key of the first server, and the first authentication information includes identification information of the user and a first public key that is paired with the first private key.

This makes it possible to perform authentication (for example, authentication as to whether the data is mobile object data linked to the user) based on whether the first signature stored in the first server can be decrypted using the first public key. This leads to a secure mechanism.

### (Technology 7)

This is the mobile object according to any one of technologies 1 to 6, further including: a storage that stores the first authentication information.

This makes it possible to store the first authentication information when the first authentication information is obtained in advance.

### (Technology 8)

This is the mobile object according to technologies 1 to 7, wherein the mobile object is a vehicle.

This makes it possible to realize a vehicle that can easily transmit mobile object data (vehicle data) from the second server to the first server while having a secure mechanism.

### (Technology 9)

This is authentication system 1 including the mobile object, the first server, and the second server according to any one of technologies 1 to 8, wherein the second server transfers, to the first server, the mobile object data to which the first authentication information and the third authentication information which have been received from the mobile object have been added, and the first server performs authentication based on: the fourth authentication information; the second authentication information; and the first authentication information and the third authentication information that have been added to the mobile object data.

This makes it possible to realize an authentication system in which authentication is performed in the first server. Such an authentication system can easily transmit mobile object data from the second server to the first server while having a secure mechanism.

### (Technology 10)

This is authentication system 1 including the mobile object, the first server, and the second server according to any one of technologies 1 to 8, wherein the second server stores the mobile object data to which the first authentication information and the third authentication information which have been received from the mobile object have been added, and when a request for the mobile object data is received from the first server, the second server performs authentication based on the fourth authentication information and the second authentication information that have been received from the first server, and the first authentication information and the third authentication information that have been added to the mobile object data.

This makes it possible to realize an authentication system in which authentication is performed in the second server. Such an authentication system can easily transmit mobile object data from the second server to the first server while having a secure mechanism.

### (Technology 11)

This is a data structure of data transmitted from the mobile object to the second server in an authentication system including the mobile object, the first server, and the second server according to any of technologies 1 to 8, the data structure including: the mobile object data of the mobile object; the third authentication information of the mobile object; and the first authentication information stored in the mobile object.

Accordingly, when data with such a data structure is transferred from the second server to the first server, authentication can be performed in the first server using the first to third authentication information. That is, since authentication is performed using the first to third authentication information, a secure mechanism exists in the authentication system. In addition, the second server only needs to transfer the mobile object data, to which the first authentication information and the third authentication information have been added, to the first server without communicating with the first server for authentication. Therefore, it is possible to realize a data structure that can easily transmit mobile object data from the second server to the first server while having a secure mechanism.

### (Technology 12)

This is the data structure according to technology 11, wherein the first authentication information includes identification information of the user and a first public key of the first server, and the third authentication information includes identification information of the mobile object and a second public key of the mobile object.

This makes it possible to transmit data including the identification information of the mobile object, the second public key of the mobile object, the identification information of the user, and the first public key of the first server to the second server. The identification information of the mobile object, the second public key of the mobile object, the identification information of the user, and the first public key of the first server are information used for authentication performed in the first server or the second server.

### (Technology 13)

This is an information processing method including: receiving first authentication information transmitted by a first server, the first server storing second authentication information from the mobile object, the first server being a server for providing a service contracted by a user of a mobile object; obtaining mobile object data of the mobile object; and transmitting, to a second server that collects mobile object data, the mobile object data to which third authentication information and the first authentication information have been added, the third authentication information being information used for authentication using the second authentication information, wherein the first server stores fourth authentication information used for authentication using the first authentication information.

This provides the effect similar to that of the mobile object described above.

### (Technology 14)

This is a non-transitory computer-readable recording medium having recorded thereon a program for causing a computer to execute the information processing method according to technology 13.

This provides the effect similar to that of the mobile object described above.

While various embodiments have been described herein above, it is to be appreciated that various changes in form and detail may be made without departing from the spirit and scope of the present disclosure as presently or hereafter claimed.

### Further Information about Technical Background to this Application

The disclosure of the following patent application including specification, drawings, and claims is incorporated herein by reference in their entirety: Japanese Patent Application No. 2024-042735 filed on Mar. 18, 2024.

### INDUSTRIAL APPLICABILITY

The present disclosure is useful for mobile objects and the like that transmit vehicle data.

1. A mobile object comprising:
a receiver that receives first authentication information transmitted by a first server that stores second authentication information from the mobile object, the first server being for providing a service contracted by a user of the mobile object;
an obtainer that obtains mobile object data of the mobile object; and
a transmitter that transmits, to a second server that collects mobile object data, the mobile object data to which third authentication information and the first authentication information have been added, the third authentication information being information used for authentication using the second authentication information,
wherein the first server stores fourth authentication information used for authentication using the first authentication information.

2. The mobile object according to claim 1,
wherein the second authentication information includes identification information of the mobile object and a second public key of the mobile object, the second public key being paired with a second private key that is used to generate a second signature included in the third authentication information.

3. The mobile object according to claim 2, further comprising:
a generator that generates the second public key and the second signature that is obtained by using the second private key of the mobile object.

4. The mobile object according to claim 3,
wherein when the mobile object obtains the first authentication information, the generator generates the second public key and the second signature.

5. The mobile object according to claim 1,
wherein the transmitter further adds information indicating a transmission destination of the first server to the mobile object data and transmits, to the second server, the mobile object data to which the information indicating a transmission destination has been added.

6. The mobile object according to claim 1,
wherein the fourth authentication information includes a first signature generated by using a first private key of the first server, and
the first authentication information includes identification information of the user and a first public key that is paired with the first private key.

7. The mobile object according to claim 1, further comprising:
a storage that stores the first authentication information.

8. The mobile object according to claim 1,
wherein the mobile object is a vehicle.

9. An authentication system comprising the mobile object, the first server, and the second server according to claim 1,
wherein the second server transfers, to the first server, the mobile object data to which the first authentication information and the third authentication information which have been received from the mobile object have been added, and
the first server performs authentication based on: the fourth authentication information; the second authentication information; and the first authentication information and the third authentication information that have been added to the mobile object data.

10. An authentication system comprising the mobile object, the first server, and the second server according to claim 1,
wherein the second server stores the mobile object data to which the first authentication information and the third authentication information which have been received from the mobile object have been added, and
when a request for the mobile object data is received from the first server, the second server performs authentication based on the fourth authentication information and the second authentication information that have been received from the first server, and the first authentication information and the third authentication information that have been added to the mobile object data.

11. A data structure of data transmitted from the mobile object to the second server in an authentication system including the mobile object, the first server, and the second server according to claim 1, the data structure comprising:
the mobile object data of the mobile object;
the third authentication information of the mobile object; and
the first authentication information stored in the mobile object.

12. The data structure according to claim 11,
wherein the first authentication information includes identification information of the user and a first public key of the first server, and
the third authentication information includes identification information of the mobile object and a second public key of the mobile object.

13. An information processing method comprising:
receiving first authentication information transmitted by a first server, the first server storing second authentication information from the mobile object, the first server being a server for providing a service contracted by a user of a mobile object;
obtaining mobile object data of the mobile object; and
transmitting, to a second server that collects mobile object data, the mobile object data to which third authentication information and the first authentication information have been added, the third authentication information being information used for authentication using the second authentication information,
wherein the first server stores fourth authentication information used for authentication using the first authentication information.

14. A non-transitory computer-readable recording medium having recorded thereon a program for causing a computer to execute the information processing method according to claim 13.
